(19) United States
(12) Patent Application Publication
(10) Pub. No.: US 2013/0288566 A1
(43) Pub. Date: Oct. 31, 2013

(54) TOY HAVING A MOTOR MOUNT

(71) Applicants: Miva A. Filoseta, Los Angeles, CA (US); Jebraeil SAMO, Rowland Heights, CA (US)

(72) Inventors: Miva A. Filoseta, Los Angeles, CA (US); Jebraeil SAMO, Rowland Heights, CA (US)

(21) Appl. No.: 13/864,864

(22) Filed: Apr. 17, 2013

Related U.S. Application Data
(60) Provisional application No. 61/625,727, filed on Apr. 18, 2012.

(51) Int. Cl. A63H 29/00; B23P 19/04

(52) U.S. Cl. CPC A63H 29/00; B23P 19/04
USPC 446/353; 29/426.1

(57) ABSTRACT

A toy having a rotating feature is provided. The toy includes a motor mount and a motor. The motor mount includes a post and a housing. The housing includes a base and at least one first arm extending from the base, the at least one first arm having a flange on an end opposite the base, the flange being rotationally coupled to the post. The motor mount further includes a biasing member coupled to the housing and arranged to rotate the housing in a first direction. The motor is coupled to the housing.

### CROSS REFERENCE TO RELATED APPLICATIONS

The present application is a nonprovisional application of U.S. Provisional Application Ser. No. 61/625,727 filed on Apr. 18, 2012, the content of which is incorporated reference herein in its entirety.

### BACKGROUND

Various embodiments disclosed herein are related to a mounting arrangement for a motor, and more particularly a motor mount that prevents overheating of the motor used in a toy.

A typical toy, such as a toy vehicle for example, may have a DC motor connected to a power supply. The motor may be coupled to one or more rotating features, such as a wheel on a car for example, that provide additional functionality and excitement to the play. The rotating feature may also provide a higher degree of realism to the play. Usually, the motor is connected to the rotating feature through one or more gears that allow the rotation of the motor to be adapted to a desired output that is appropriate for the type of play of the toy.

During play it is not uncommon for the user to contact or grab onto the rotating feature. As a result, the feature will stop rotating and become immobilized. It should be appreciated that when the rotation of the feature is halted, all the components within the drivetrain of the feature will also stop rotating, including the motor. Since most toys have relatively simple control systems, there will be no means for detecting this interruption in the rotation of the components. As a result, electrical power from the power supply will continue to flow to the motor causing an increase in the temperature of the motor, potentially causing the motor to overheat. It should be appreciated that overheating the motor may result in reduced life and lower reliability.

Accordingly, while existing toy motor systems are suitable for their intended purposes the need for improvement remains, particularly in providing a motor mount that allows disengagement of a gear when a rotating feature on a toy is immobilized.

### SUMMARY OF THE INVENTION

In one embodiment, a toy having a rotating feature is provided. The toy includes a motor mount having a post. The motor mount further includes a housing having a base and at least one first arm extending from the base, the at least one first arm having a flange on an end opposite the base, the flange being rotationally coupled to the post. The motor mount further includes a biasing member coupled to the housing and arranged to rotate the housing in a first direction. A motor is coupled to the housing.

In another embodiment, a method of disengaging a toy motor from a rotating feature is provided. The method includes biasing a housing holding the toy motor into a first position. A pinion on the toy motor engages with the rotating feature. The housing rotates into a second position when the rotating feature is immobilized. The pinion is disengaged from the rotating feature when the housing is in the second position.

### BRIEF DESCRIPTION OF THE DRAWINGS

These and/or other features, aspects, and advantages of the present invention will become better understood when the following detailed description is read with reference to the accompanying drawings in which like characters represent like parts throughout the drawings, wherein:

FIG. 1 is a perspective view of a toy motor and mounting arrangement in accordance with an embodiment of the invention;

FIG. 2 is another perspective view of the toy motor and mounting arrangement of FIG. 1;

FIG. 3 is another perspective view of the toy motor and mounting arrangement of FIG. 1;

FIG. 4 is a top view of the toy motor and mounting arrangement of FIG. 1;

FIG. 5 is a perspective view of a housing for the toy motor and mounting arrangement of FIG. 1;

FIG. 6-FIG. 9 are perspective views of an another embodiment of the housing in accordance with an embodiment of the invention;

FIG. 10 is a perspective view of the housing of FIGS. 6-9 coupled to a frame;

FIG. 11-FIG. 12 are perspective views of the housing of FIGS. 6-9 with a motor installed;

FIG. 13-FIG. 14 are illustrations of a motor mounting arrangement in accordance with another embodiment of the invention;

FIG. 15-17 are top views of the toy motor and mounting arrangement coupled to a rotating feature;

FIGS. 18A-18C are a perspective view of a toy having the motor and motor mounting arrangement of FIGS. 1-17; and

FIG. 19 is a perspective view of a toy motor and mounting arrangement in accordance with another embodiment of the invention.

Although the drawings represent varied embodiments and features of the present invention, the drawings are not necessarily to scale and certain features may be exaggerated in order to illustrate and explain exemplary embodiments the present invention. The exemplification set forth herein illustrates several aspects of the invention, in one form, and such exemplification is not to be construed as limiting the scope of the invention in any manner.

### DETAILED DESCRIPTION

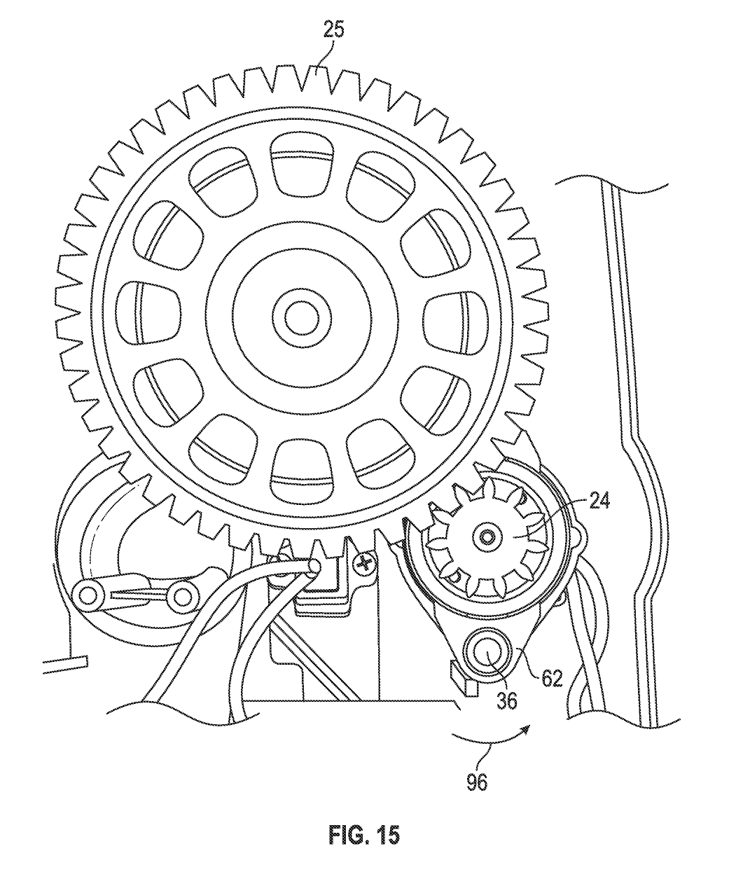

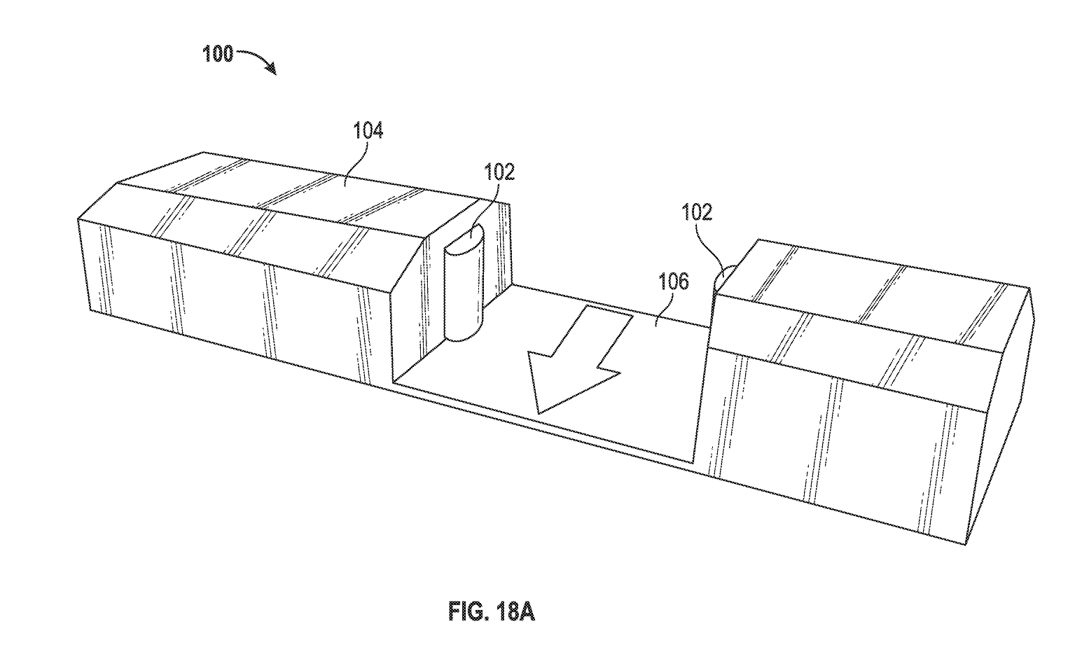

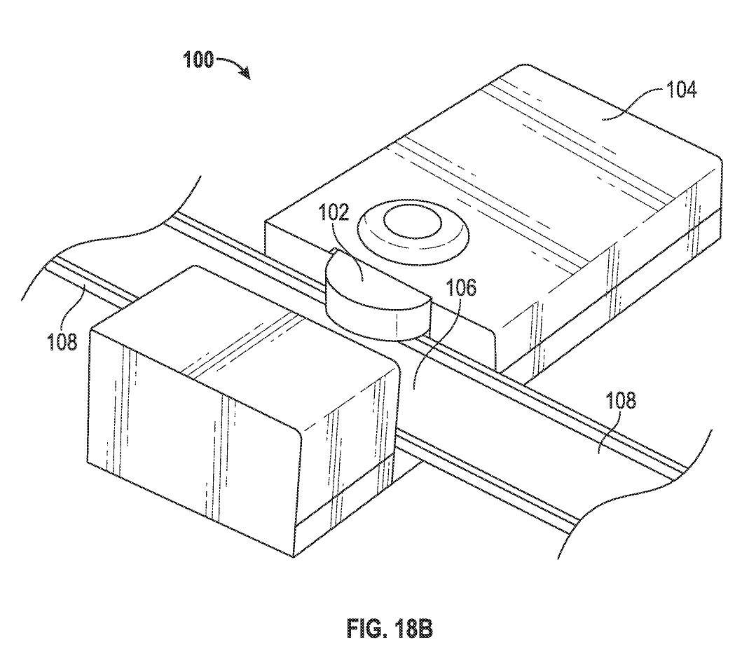

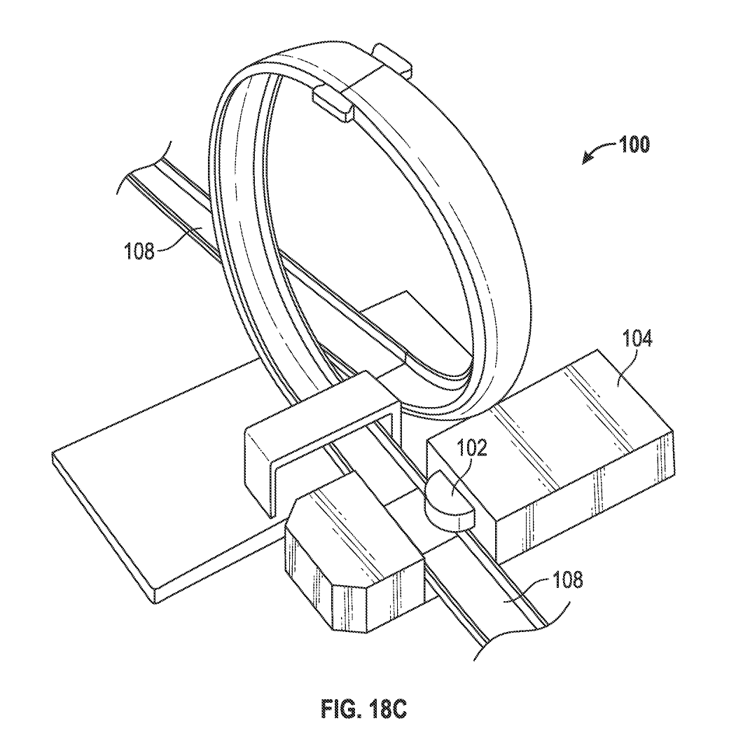

Referring now to the attached FIGS., a toy 100 having a motor 20 and motor mounting arrangement 22 constructed in accordance with one non-limiting embodiment is illustrated. Embodiments of the invention provide advantages in allowing the motor 20 to automatically rotate or move to disengage a pinion gear 24 (FIG. 15) when a rotating feature 102 (FIG. 18) on the toy 100 is immobilized. Embodiments of the invention provide further advantages in reducing temperature rise in the motor when the rotating feature 26 is immobilized. Embodiments of the invention provide still further advantages in improving the life and the reliability of the motor increasing the enjoyment of the user over a longer period of time.

In one non-limiting embodiment, the motor 20 has a generally cylindrical body 28 having one or more conductors 30 that connect the motor 20 to a power supply (not shown). The motor 20 may be a brushless DC type motor for example. The motor 20 includes a shaft 32 extending from an end 34. The pinion gear 24 is mounted to the shaft 32 allowing the pinion gear 24 to rotate when the motor 20 is energized. In the exemplary embodiment, the pinion gear 24 is connected to one or more gears 25 in a drive train that connect the pinion gear 24 to a rotating feature 102 on the toy 100. It should be appreciated that while embodiments herein illustrate the rotating feature 102 as a wheel, the rotating feature 102 may be any feature on a toy that rotates, such as but not limited to a propeller blade, a helicopter blade, a booster wheel on a car launching track set, an arm or leg or other body feature for example.

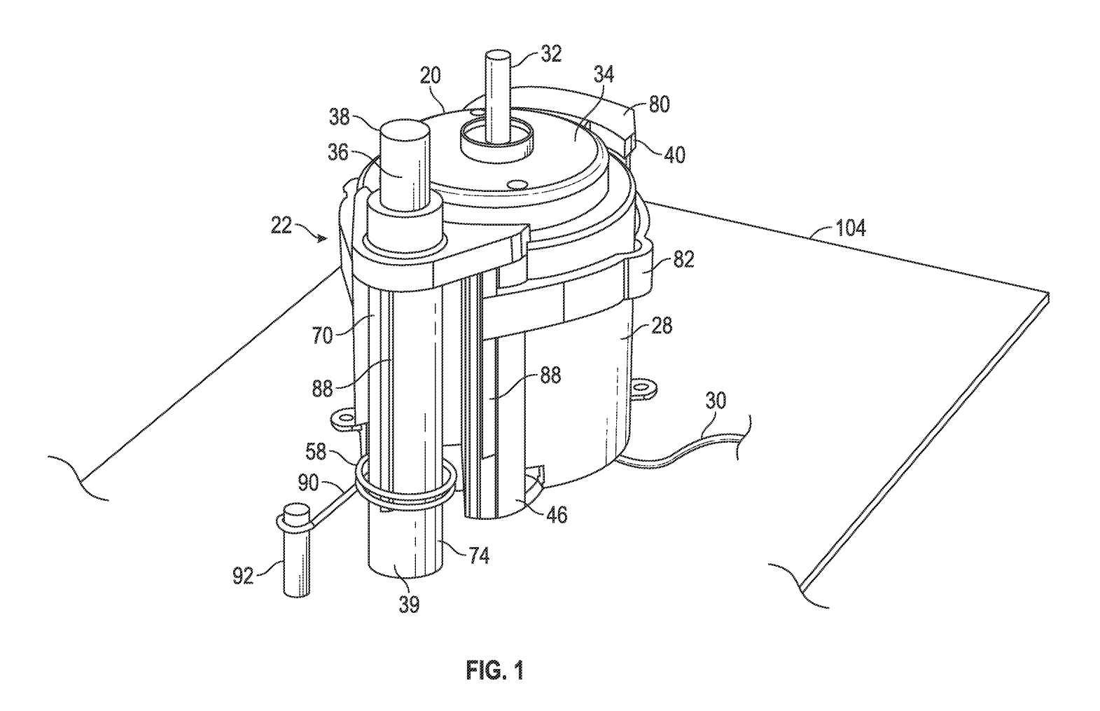

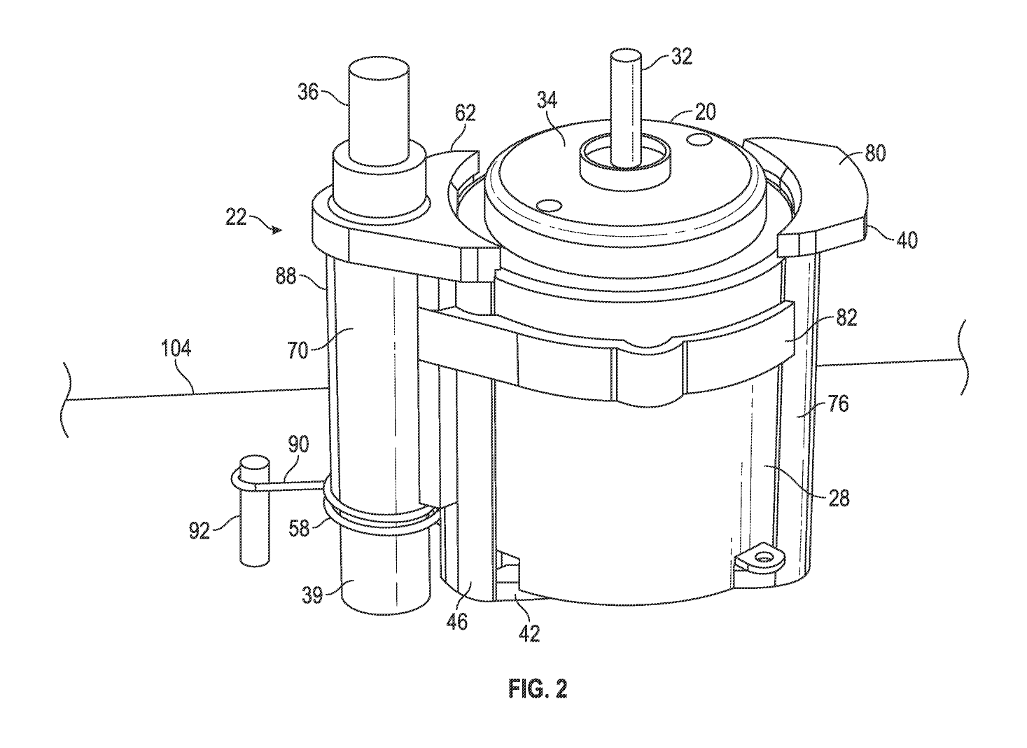

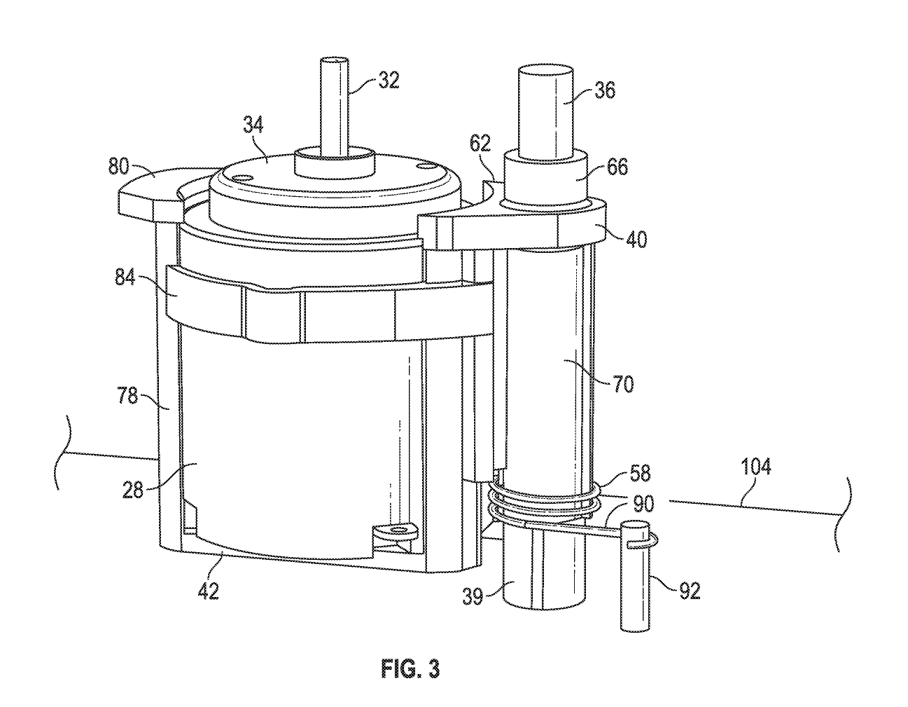

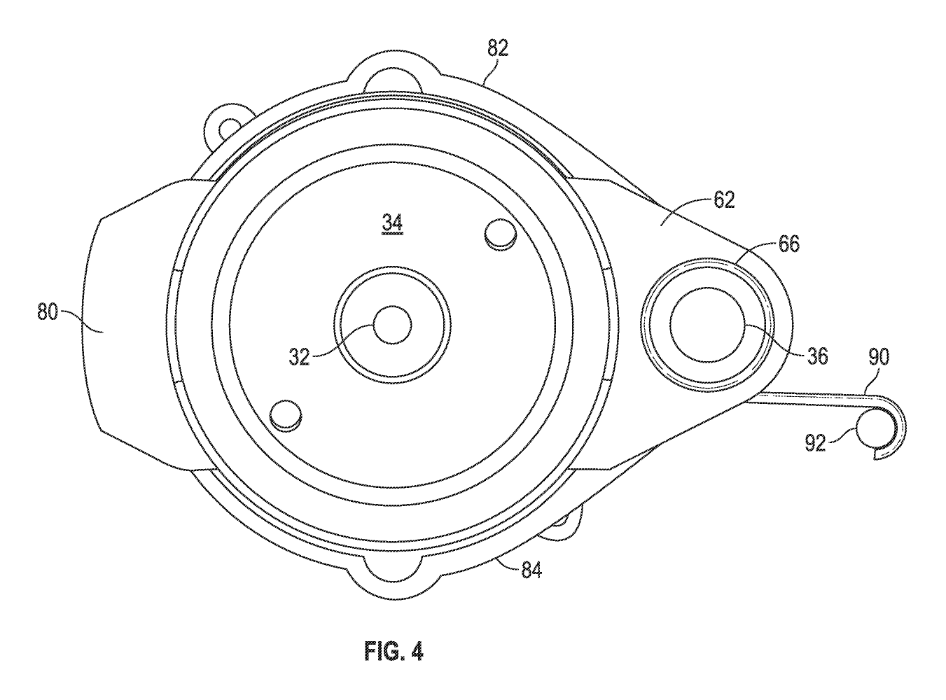

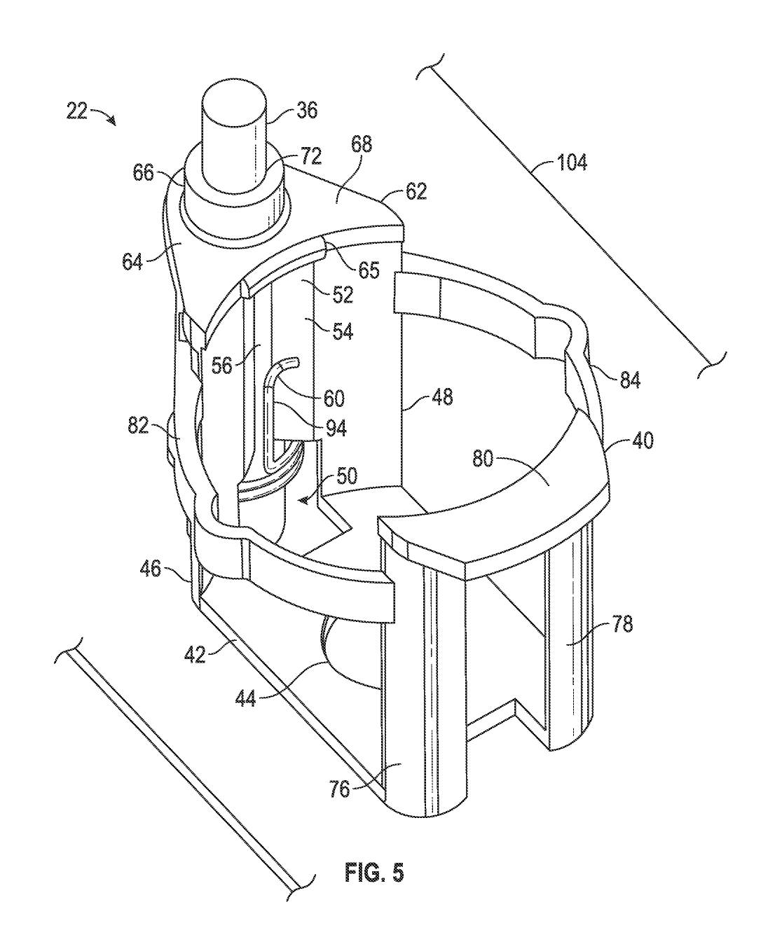

The motor 20 is coupled to the toy 100 by the motor mounting arrangement 22. Referring now to FIGS. 1-5, one non-limiting embodiment of the invention is illustrated. In this embodiment, the motor mounting arrangement 22 includes a post 36 that is coupled to a frame 104 of toy 100. The post 36 may be made from any suitable material, such as steel or plastic for example, that is capable of withstanding the force and torque imposed on the post 36 by the operation of the toy 100. The post 36 extends from the frame 104 in a cantilevered arrangement terminating in a free end 38. Disposed on the post 36 is a standoff 39 that is arranged on an end adjacent the frame 104. In one non-limiting embodiment, the standoff 39 is integral with the post 36. In another non-limiting embodiment, the standoff 39 is integrated with the frame 104. As will be discussed in more detail below, the post 36 and standoff 39 have a surface finish suitable to allow the motor mounting arrangement 22 to rotate during operation.

A housing 40 is coupled for rotation to the post 36. The housing 40 may be made from any suitable material, such as but not limited to a plastic such as polycarbonate, polypropylene, or polyethylene for example. In this embodiment, the housing 40 includes a planar base portion 42 that is arranged to support the end of the motor 20 opposite the shaft 32. The base 42 may have a centrally positioned opening 44 that provides a relief for features on the motor 20 or allows for additional air flow to the motor 20 to assist in thermal management of the motor during operation. Arranged on one end of the base 42 is a first set of arms 46, 48 that extend substantially perpendicular to the base 42. The arms 46, 48 are separated by a gap 50, as will be discussed in more detail below, the gap 50 provides a relief to allow a torsion spring 58 to cooperate with the housing 40. In one non-limiting embodiment, the gap 50 includes a portion that extends into the base 42.

The arms 46, 48 are connected by a wall 52 arranged opposite the base 42 from the gap 50. The wall 52 includes a pair of angled surfaces 54, 56 that form a recessed area sized to receive an end 60 of the torsion spring 58. Extending from the arms 46, 48 and wall 52 on an end opposite the base 42 is a flange 62. The flange 62 includes a first portion 64 that extends in a direction substantially opposite the base 42. The flange 62 may also include a second portion 65 that extends in a substantially opposite direction from the first portion 64. In one non-limiting embodiment, the second portion 65 contacts the end 34 of motor 20 to retain the motor 20.

In the exemplary embodiment, the flange 62 includes a first cylindrical projection 66 extending from a first side 68. Extending from an opposite side of the first portion 64 is a second cylindrical projection 70. An opening 72 extends through the first cylindrical projection, the first portion 64 and the second cylindrical portion 70. The opening 72 is sized and shaped to receive the post 36. As will be discussed in more detail below, the opening 72 defines an axis of rotation that allows the motor mounting arrangement 22 to move in response to immobilization of the rotating feature 102. In one non-limiting embodiment, the second cylindrical projection 70 extends past the end of the wall 52 and has an end 74 disposed adjacent the gap 50. The end 74 contacts the standoff 39 to support the motor mounting arrangement 22 and the motor 20 during operation. In addition, the motor mounting arrangement 22 also positions the motor 20 above a surface of the frame 104 such that vibrational noise is prevented. In still one further non-limiting embodiment, a vibration damping member may be positioned between the post 36 and the inner diameter of opening 72.

The housing 40 may further include a second pair of arms 76, 78 that extend from the base 42 on an end opposite the arms 46, 48. The second pair of arms 76, 78 are coupled on an end opposite the base 42 by a second flange 80. The second flange may include a projection 86 arranged opposite second portion 65. The arms 46, 48, the arms 76, 78 and the base 42 form a generally U-shaped housing that defines a space sized to receive and retain the motor 20. In one non-limiting embodiment, the first set of arms 46, 48 and the second set of arms 76, 78 are connected by struts 82, 84.

It should be appreciated that the housing 40 may also include ribs, such as ribs 88 for example, that provide for a desired structural rigidity or to facilitate injection molding of the housing.

The motor mounting arrangement further includes a biasing member, such as torsion spring 58 for example. The torsion spring 58 is disposed about the second cylindrical projection 70 adjacent the gap 50. In one non-limiting embodiment, a portion of the body of the torsion spring 58 is positioned within the gap 50. The torsion spring 58 includes a first arm 90 that connects with a feature on the frame 104, such as a pin 92. The torsion spring 58 further includes a second arm 94 having an end 60 that is positioned within the recess formed by the surfaces 54, 56. It should be appreciated that the pin 90 fixes the end of the torsion spring 58 relative to the frame 104 allowing the torsion spring 58 to bias the housing 40 such that housing 40 will rotate about an axis defined by the opening 72 and post 36.

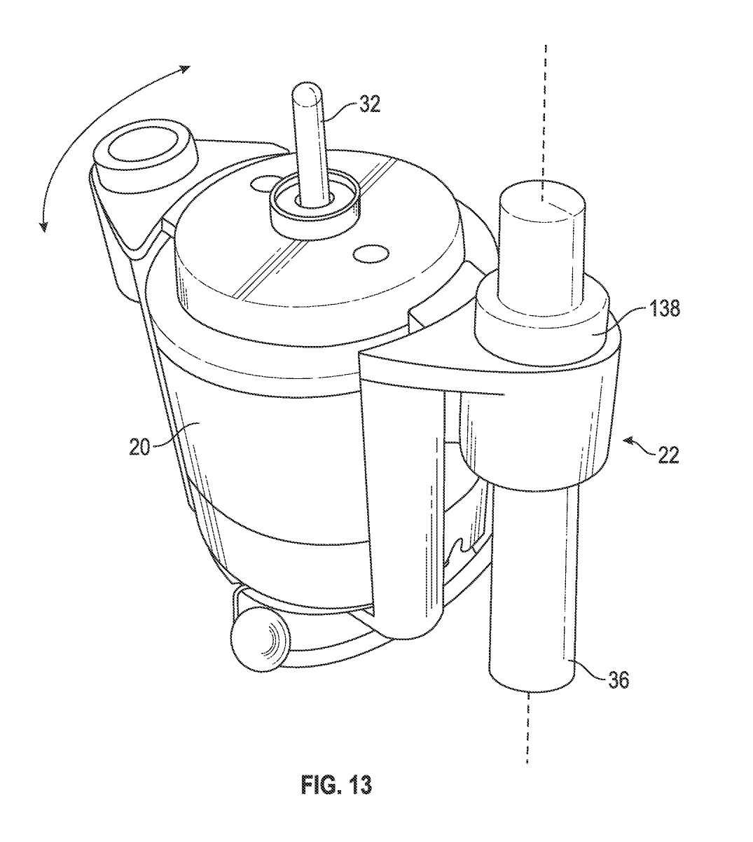

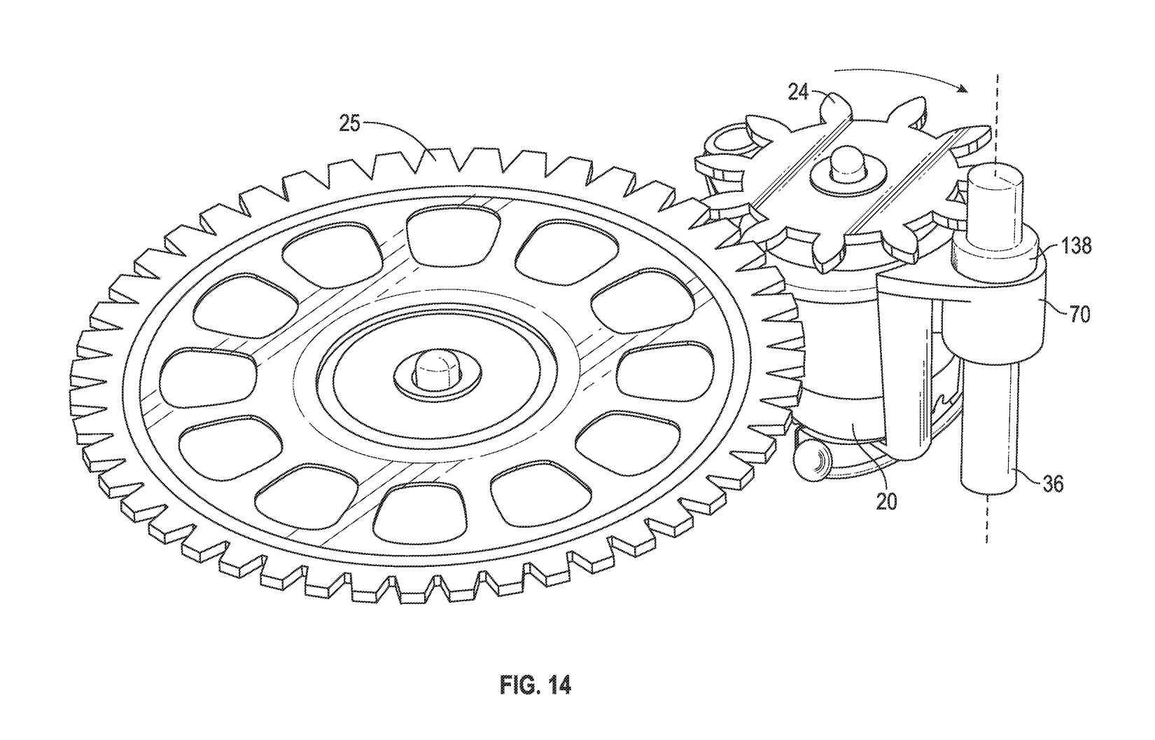

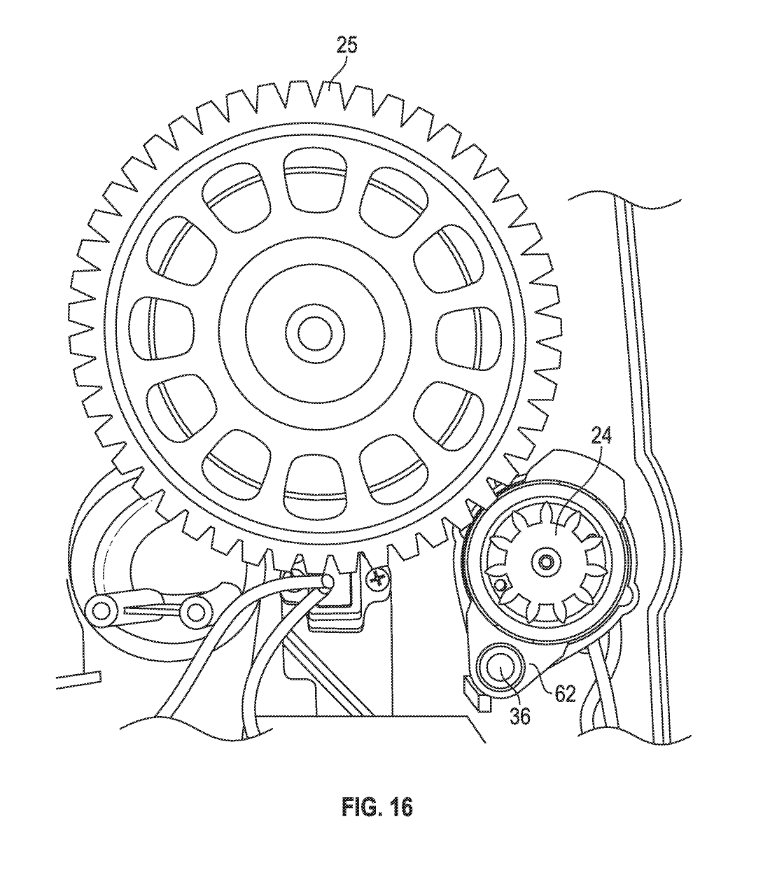

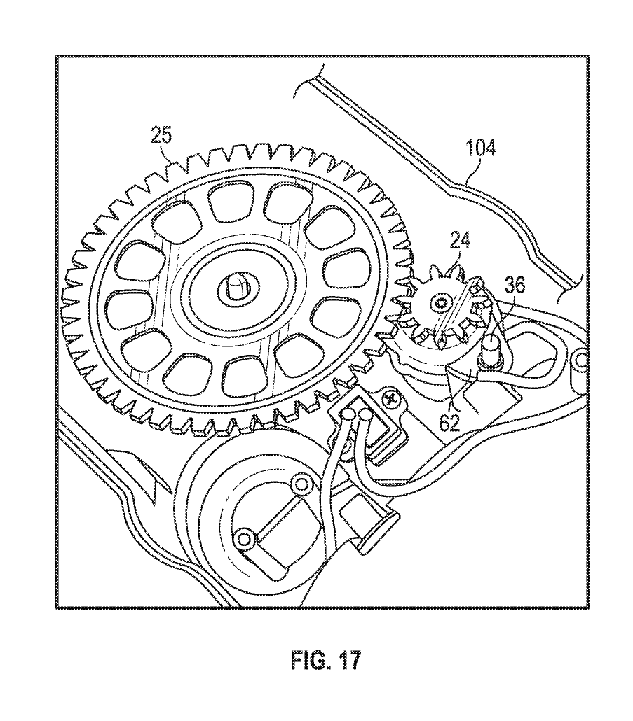

Referring now to FIGS. 13-17, the operation of the motor 20 and motor mounting arrangement 22 will be described. During operation, the torsion spring 58 biases the motor mounting arrangement 22 in the direction of arrow 96 such that the pinion gear 24 engages the gear 25 (FIG. 15). When the motor 20 is energized, the motor 20 will rotate shaft 32 causing the pinion gear 24 to rotate. The engagement of the pinion gear 24 with gear 25 results in the rotation of the rotating feature 102. In the event that the rotating feature 102 is immobilized (e.g. a user holds the wheel), then the gear 25 will also be immobilized. If the motor 20 is still energized, then torque will continue to be applied to the shaft 32. The motor torque of motor 20 will overcome the spring tension of torsion spring 58 causing the pinion gear 24 to move away from the gear 25 such that the motor 20 is disengaged from the rotating feature 102. Thus, further rotation of the pinion gear 24 is possible even though other portions of the drive train are bound. It should be appreciated that while disengaged, the motor 20 will continue to rotate and temperature increase in the motor 20 may be avoided.

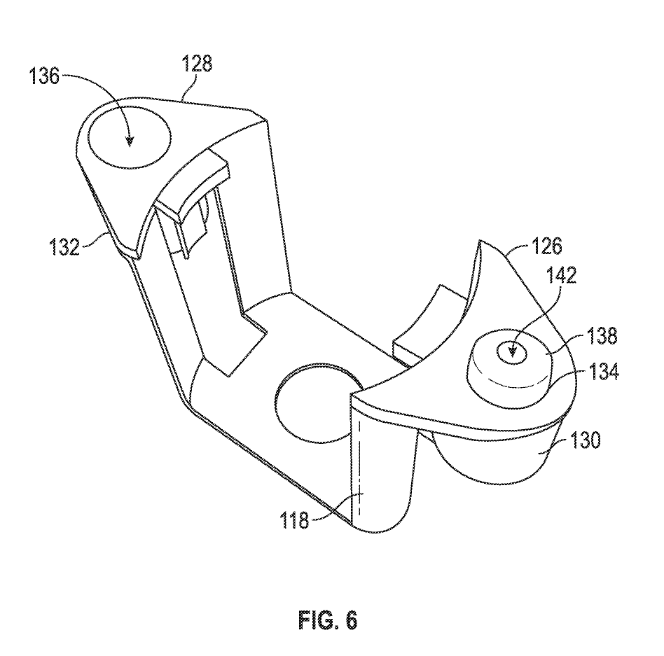

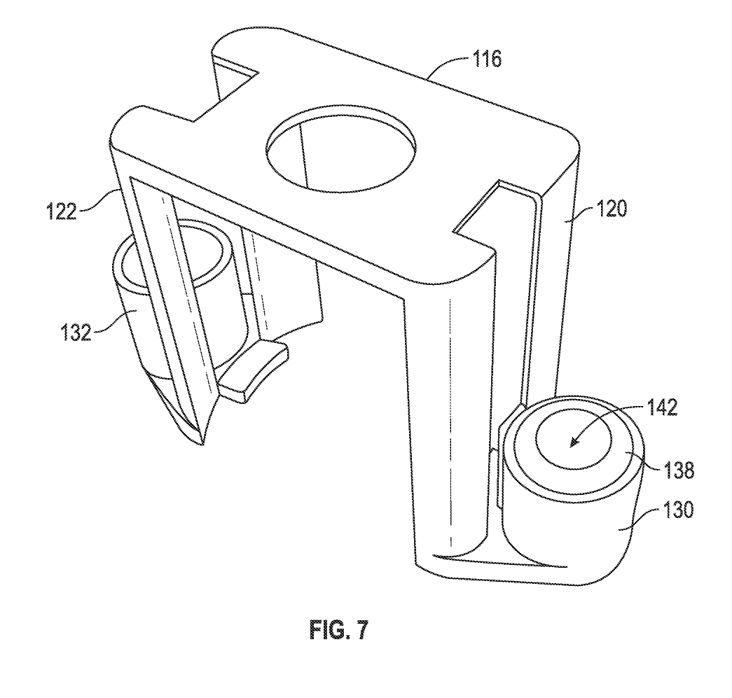

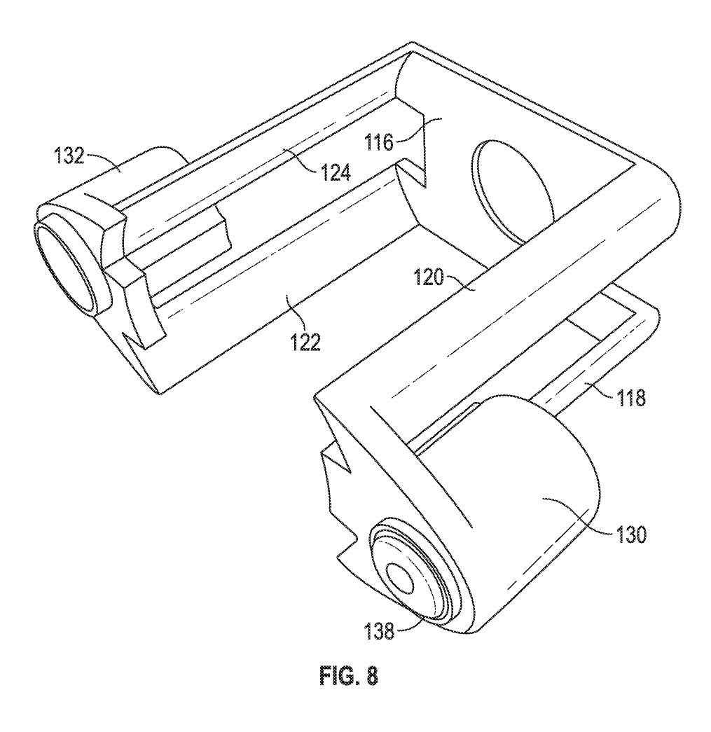

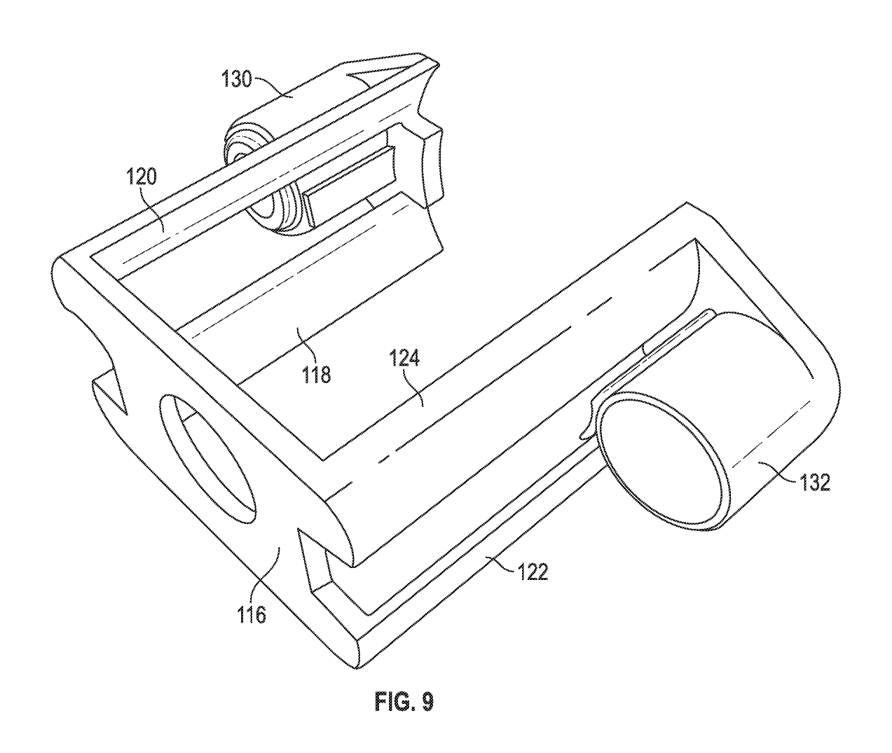

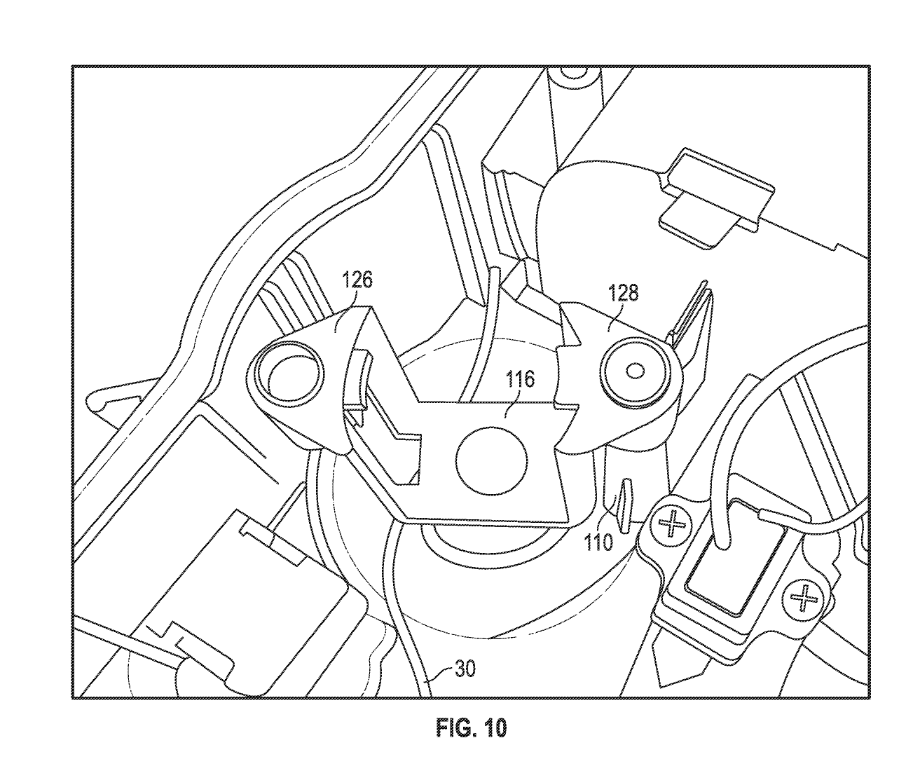

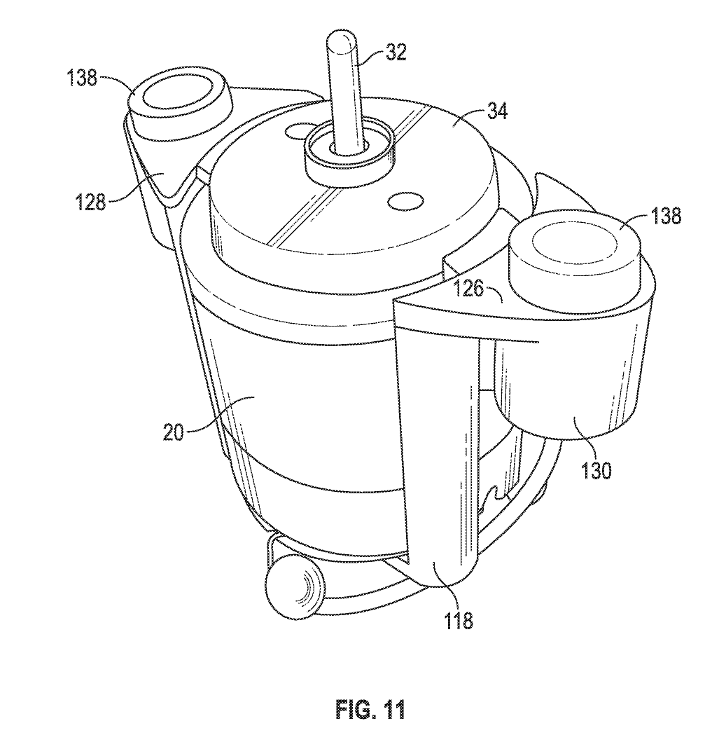

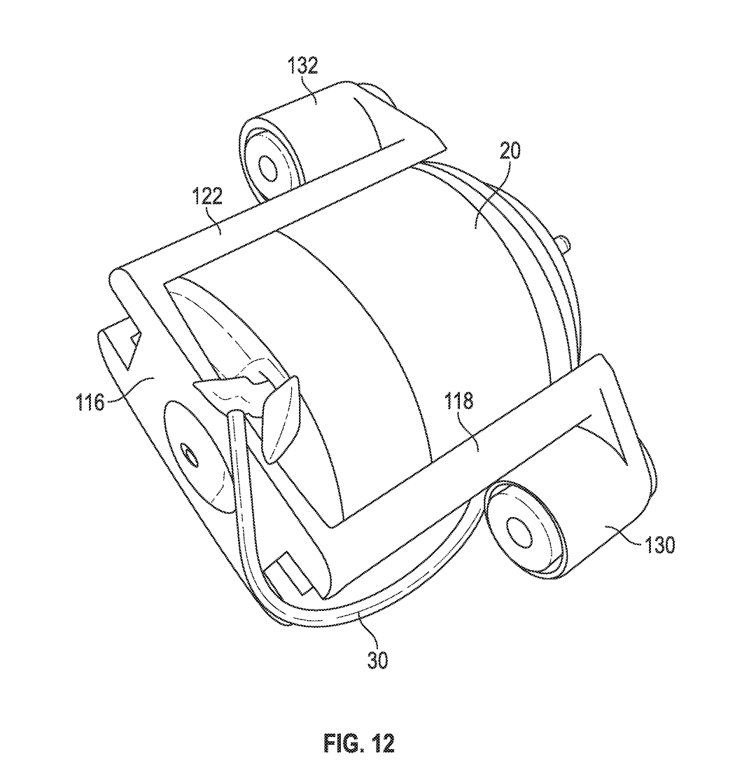

Referring now to FIGS. 6-12, another embodiment of the motor mounting arrangement 22 is shown having two supporting posts 110, 112. In this embodiment, motor mounting arrangement 22 includes a housing 114 having a substantially planar base portion 116. Extending from a first end of the base is a first set of arms 118, 120. A first flange 126 is arranged on the end of the arms 118, 120. Extending from a second end of the base is a second set of arms 122, 124. A second flange 128 extends from the end of the second set of arms 122, 124 in a direction substantially opposite the first flange 126.

Each flange 126, 128 includes a cylindrical projection 130, 132 extending in a direction toward the base 116. Openings 134, 136 are formed in and extend through the flanges 126, 128 and projections 130, 132 respectively. The openings 134, 136 are sized to receive a vibration damping member 138, 140. The vibration damping members 138, 140 include an opening 142, 144 sized to receive one of the posts 110, 112 respectively.

Each of the flanges 126, 128 may include a projection 146, 148 that are disposed opposite each other. The projections 146, 148 are sized and positioned to engage the end 34 of the motor 20 to retain the motor 20 to the motor mounting arrangement 22.

Similar to the embodiments discussed above, the motor mounting arrangement 22 is arranged to engage the pinion gear 24 with the gear 25 such that when the motor is energized, the pinion gear 24 will rotate the gear 25 and the rotating feature 102. If the rotating feature 102 is immobilized, the gear 25 will similarly stop. The motor torque of the motor 20 will overcome the elasticity of the vibration damping member 138, 140 causing the motor mounting arrangement to rotate or twist about the vibration damping members 138, 140 allowing the pinion gear 24 to disengage from the gear 25. Once the pinion gear 24 is disengaged, the motor 20 may then rotate and temperature rise within the motor 20 may be avoided.

Referring now to FIGS. 18A-18C, embodiments of a toy 100 are shown of a toy vehicle booster device. The toy 100 uses the motor 20 and motor mounting arrangement 22 to rotate a pair of rotating features 102. The rotating features 102 are disposed on opposing sides of a toy vehicle pathway 106. The pathway 106 may be coupled to one or more other track pathways 108 that direct a toy vehicle (not shown) into the booster device 100. When the toy vehicle enters the pathway 106, the rotating features 102 touch the sides of the toy vehicle and impart an impulse onto the toy vehicle further propelling the toy vehicle along the track pathway 108.

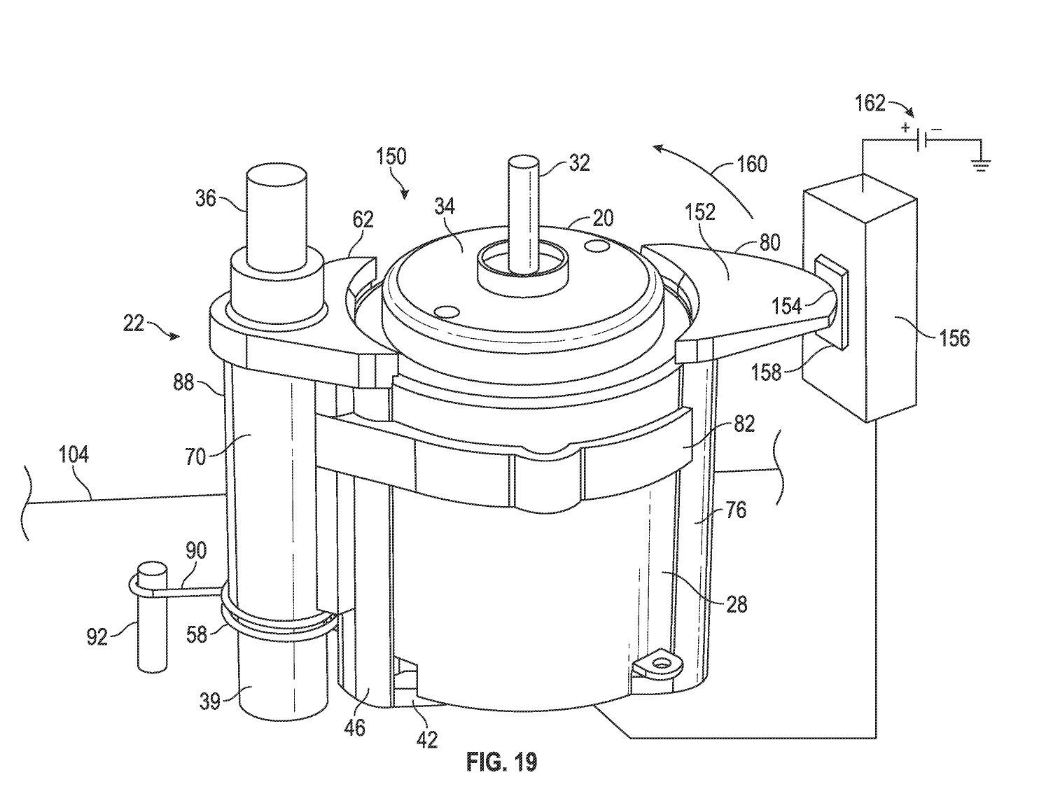

Referring now to FIG. 19, another embodiment of a motor mounting arrangement 150 is shown that includes a means for de-energizing the motor in response to a stall condition. In this embodiment, the motor mounting arrangement 150 is substantially similar to the construction of motor mounting arrangement 22 described in reference to FIGS. 1-5. In this embodiment, the housing 40 includes a second flange 152. The second flange 152 has an elongated shape with a distal end 154. Positioned adjacent the end 154 is a switch 156 having an actuator member 158. The end 154 is shaped such that when the motor 20 rotates (in the direction indicated by arrow 160) the motor mount arrangement 150 under a stall condition, the end 154 engages the actuator member 158. The switch 156 is electrically coupled between the motor 20 and a power source 162. The switch 156 is configured to electrically decouple the motor 20 from the power source 162 when the actuator member 158 is depressed. In one non-limiting embodiment, the switch 156 is a microswitch.

During operation the biasing spring 58 bias' the motor mounting arrangement 150 such that the pinion gear 24 engages the gear 25 (FIG. 15). When the motor 20 is energized, the shaft 32 is rotated causing the pinion gear to rotate. This results in the rotation of the rotating feature 102 as discussed above. In the event the rotating feature 102 is immobilized, the motor will enter a stall condition with the gear 25 also immobilized. Due to motor torque, the torque from torsion spring 58 will be overcome allowing the motor mounting arrangement 150 to rotate about the post 36. As the motor mount arrangement 150 rotates, the end 154 moves from a position offset from the actuator member 158 into contact with the actuator member 158. As the actuator member 158 is depressed, the motor 20 is decoupled from the energy source 162 and the motor 20 is de-energized and a temperature increase in the motor 20 is avoided. In one nonlimiting embodiment, as the motor mounting arrangement 150 rotates, the pinion gear 24 moves away from the gear 25 to disengage the motor 20 from the rotating feature 102.

As used herein, the terms “first,” “second,” and the like, herein do not denote any order, quantity, or importance, but rather are used to distinguish one element from another, and the terms “a” and “an” herein do not denote a limitation of quantity, but rather denote the presence of at least one of the referenced item. In addition, it is noted that the terms “bottom” and “top” are used herein, unless otherwise noted, merely for convenience of description, and are not limited to any one position or spatial orientation.

The modifier “about” used in connection with a quantity is inclusive of the stated value and has the meaning dictated by the context (e.g., includes the degree of error associated with measurement of the particular quantity).

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A toy having a rotating feature comprising:
a motor mount comprising:
a post;
a housing having a base and at least one first arm extending from the base, the at least one first arm having a flange on an end opposite the base, the flange being rotationally coupled to the post;
a biasing member coupled to the housing and arranged to rotate the housing in a first direction; and
a motor coupled to the housing.

2. The toy of claim 1 wherein the housing further includes a cylindrical tube extending from the flange, the post being arranged within the cylindrical tube.

3. The toy of claim 2 wherein the biasing member is a torsion spring disposed about the cylindrical tube.

4. The toy of claim 3 further comprising a standoff disposed on the post, wherein an end of the cylindrical tube opposite the flange is in contact with the standoff.

5. The toy of claim 4 further comprising a vibration damper between the post and an inner wall of the cylindrical tube.

6. The toy of claim 5 wherein the housing includes at least one second arm extending from the base opposite the at least one first arm, the base, the at least one first arm and the at least one second arm defining an area sized to receive the toy motor.

7. The toy of claim 1 wherein the housing is rotatable between a first position wherein the motor engages the rotating feature and a second position wherein the toy motor is disengaged from the rotating feature.

8. The toy of claim 7 wherein the biasing member arranged to bias the housing into the first position.

9. The toy of claim 1 further comprising a pin arranged adjacent the post, wherein the torsion spring has a first end coupled to the pin and a second end coupled to the first arm.

10. The toy of claim 5 further comprising:
a first gear coupled to the toy motor;
a second gear coupled to the rotating feature; and
wherein the first gear is configured to move from an engaged position to a disengaged position when the second gear is immobilized.

11. The toy of claim 1 wherein the housing is u-shaped.

12. The toy of claim 1 wherein the housing rotates about the centerline of the post.

13. A method of disengaging a toy motor from a rotating feature comprising:
biasing a housing holding the toy motor into a first position;
engaging a pinion on the toy motor with the rotating feature;
rotating the housing into a second position when the rotating feature is immobilized; and
disengaging the pinion from the rotating feature when the housing is in the second position.

14. The method of claim 13 wherein the housing is rotated on a post.

15. The method of claim 14 further comprising biasing the housing with a torsion spring disposed on the post.

16. The method of claim 15 further comprising damping vibrations from the housing to the post with a member disposed between the housing and the post.

17. The method of claim 16 wherein the housing is rotated on the member.
